(19) United States
(12) Patent Application Publication
(10) Pub. No.: US 2007/0117496 A1
(43) Pub. Date: May 24, 2007

(54) Method for preparing decorative elements

(76) Inventor: Pnina Maron, Moshav Eilshama (IL)

Correspondence Address: Kevin D McCarthy;Roach Brown McCarthy & Gruber, 1620 Liberty Building, Buffalo, NY, 14202, US

(21) Appl. No.: 10/572,114

(22) PCT Filed: Sep. 14, 2004
(86) PCT No.: PCT/IL04/00847

§ 371 Date: Dec. 13, 2006

(30) Foreign Application Priority Data
Sep. 18, 2003 (IL) 158016

(51) Int. Cl. B24B 1/00

(52) U.S. Cl. 451/29

(57) ABSTRACT

A process for making a slab of, e.g., stone, wood, White Granite and the like, decorative element, by sandblasting therein a relatively deep cavity, using a jet of particles having at least hardness 7 that are forced through a resilient PVC (Poly Vinyl Chloride) mask, which protects the surfaces of the slab that are not intended to be sandblasted. Using the PVC mask allows obtaining a rather deep cavity in the slab without having to frequently replace the mask due to wear, and also allows obtaining cavities with edges that have contour lines that are essentially identical to the contour lines of the windows in the mask. Utilization of PVC masks impart to the cavities conspicuous artistic appearance, thereby beatifying the appearance of the ornamental slab. Then, the slab is made an ornamental slab, by incorporating two and/or three dimensional ornamental elements (e.g., dried flowers, shells of various kinds, clams, cockles, scallops, blue mussels, various colored stones, metal plastic or wood elements, mirrors, pearls, light sources, etc.) into the cavity. Then, the cavities are covered with a covering sheet for protecting the ornamental elements residing therein. The covering sheet is made of a desired material, which may be transparent or semi-transparent, and may have different shapes and colors.

### FIELD OF THE INVENTION

The present invention relates to the field of decoration. More particularly, the present invention relates to a process for making a slab of, e.g., stone, wood, and the like, decorative element.

### BACKGROUND OF THE INVENTION

Ever since the dawn of civilization, stones have been a major component in various aspects of the culture of human beings. For example, stones have long been utilized as memorial markers, for memorializing the deceased. In some cultures, stones, having random shape and sizes, were just put over burial sites, to mark the burial location. In other cultures, the memorial stones were embellished in various ways, for example, by carving, or etching, the stones. Carved stones and wood have also been utilized for adorning the exterior and interior sides of buildings, and as ‘stand-alone’ pieces of art.

Stone slabs have also been utilized as tiles, for paving roadways, covering floors of apartments and for covering walls. In some cases, in order to adorn, for example, a holy place, mosaic-based patterns were incorporated into its floor or walls, or portions thereof. The mosaic comprises small pieces of colored stones and/or glass, which, when combined in a particular way, create the required pictorial, or artistic, effect.

The mosaic technique has also been used in other applications in stone. For example, U.S. Pat. No. 4,036,929 discloses a method for embellishing memorial stones by the addition of a mosaic on the surface. The mosaic is produced by cutting a cavity in the stone, placing a base resin and mortar resin into the cavity, and inserting decorative chips into the mortar resin to form the desired embellishment. Each decorative figure that is made according to U.S. Pat. No. 4,036,929 has essentially the shape of a flat mosaic.

With the increasing level of living standard in the modern world, a lot of intention has been drawn to tiles for covering the floor and walls of apartments. Improvements in the industrialization of the making of tiles have made available a large selection of inexpensive tiles of various standard sizes and colorful patterns, from which one can choose for covering his apartment's floor, or walls. Such tiles are mostly made of ceramic materials, and their thickness largely depends on the application. However, ceramic tiles are usually thin and therefore can not include three dimensional ornamental elements. In some cases, ceramic tiles are painted with a thick layer of paint, in order to impart some depth to the pattern that is painted on the ceramic tile(s).

Sandblasting techniques are conventionally used in various industrial fields, including for artistic purposes. For example, sandblasting is used for carving decorative patterns in glass and in other materials. According to the above mentioned U.S. Pat. No. 4,036,929, a sandblasting technique is used for cutting the shallow cavity into which the mosaic is placed.

Laser techniques are also utilized for cutting in various materials for various purposes. In general, the output energy of a laser device is concentrated to a very narrow beam, which makes it very effective for cutting most accurate lines in various materials. For example, laser technology is currently utilized for cutting out the same ornamental pattern from two slabs having different colors, and ‘implanting’ in each slab the pattern with the other color. The output energy of a laser beam can be utilized for treating the surface of objects, and also for creating cavities therein, provided that the energy of the laser beam is tuned to the correct level. Despite of the wide range of uses of laser technology, the inventor is not aware of using laser technology for creating deep cavities in hard materials, such as Porcelain Granite, for creating decorative objects in the way disclosed in the present invention. In addition, laser technology is expensive, which would render the ornamental slabs, produced by its utilization, expensive.

Conventional techniques are generally characterized in that they teach utilizing ceramic tiles for covering floors and walls, or they teach how two dimensional mosaic decorations could be formed for various goals. Other prior art publications teach using sandblasting techniques to make cavities in a stone. However, sandblasting techniques are conventionally used for treating a relatively thin layer near the surface of a material. In addition, none of the prior art publications teaches either how to rapidly sandblast deep cavities in a stone or the like., in particular in White Granite (known by its commercial names as Porcelain Granite, White Ironstone, Pearl China, Pearl Granite, Flintware, and Opaque China) or in other materials having similar hardness, or how to incorporate three dimensional decorative elements into a deep cavity created in a stone, wood or the like, which could then be utilized, for example, to cover a floor or a wall of an apartment, or be used as a ‘stand-alone’ decorative element.

It is therefore an object of the present invention to provide a method for rapidly making deep cavities in hard materials, such as White Granite, while imparting to them artistic appearance.

It is another object of the present invention to provide decorative tiles and objects by using the method of the present invention.

Other objects and advantages of the invention will become apparent as the description proceeds.

### SUMMARY OF THE INVENTION

The following definitions are used in this application:
By ‘slab’ is generally meant a piece of a thick plate or slice (as of stone, clay, wood, metal, polymer and similar materials). With respect to the present invention, the wording ‘slab’ refers also to a slab-like element that consists of two or more individual slices. Therefore, by ‘slab’ is meant herein to a slab that consists, in some cases, of one plate or slice, and in other cases of two or more plates or slices.
By ‘cavity’ is meant herein a deep recess that is formed in the surface of a slab by sandblasting (‘deep’—about 8 millimeters minimum).
By ‘sandblasting’ is generally meant a known process that includes spraying a jet of sand onto the surface of a material, for cleaning and carving purposes. With respect to the present invention, the term ‘sandblasting’ refers to spraying a jet of sand, or fine particles of other materials, onto the surface of a material, whose hardness is at least 7.
By ‘hardness’ is meant the measure of a mineral's resistance to abrasion, which reflects the atomic structure of the mineral.
By ‘7’ is meant a hardness of quartz, according to Mohs hardness scale.
By ‘covering sheet’ is meant herein a piece of a transparent or semi-transparent (in whole or in parts), or colored (in whole or in parts) plate that fully covers the slab or only the open side (‘opening’) of the cavity, to protect ornamental elements placed in the cavity. The covering sheet can be made of glass (hardened/reinforced or not, depending on the desired application), polymer, or any other substance suitable for the purposes of the present invention.
By ‘ornamental slab’ it is meant herein a slab with a cavity containing ornamental elements. The ornamental slab, or only its cavity, can be sealed with a covering sheet, or left uncover.

The inventor of this invention has found that a relatively deep cavity (e.g., 15 mm) can be rapidly formed in a hard material such as White Granite by sandblasting using a jet of particles having at least hardness 7. An exemplary kind of sand, the characteristics of which are described herein below, is capable of rapidly creating cavities in, e.g., White Granite if carried by a stream of air pressurized to seven atmospheres minimum.

The inventor of this invention has also found, that PVC (Poly Vinyl Chloride) is resistant to the projected sand, and therefore, use of a PVC based mask protects the surfaces of the slab that are not intended to be sandblasted, and allows obtaining a deep cavity without having to frequently replace the mask due to wear. In addition, using a PVC based mask allows obtaining cavities with edges that have contour lines that are essentially identical to the contour lines of the windows in the mask. Utilization of PVC masks impart to the cavities conspicuous artistic appearance, thereby beatifying the appearance of the ornamental slab.

The present invention provides a method for rapidly making deep cavities in a scab, the method comprising:
a) Providing the slab with a desired shape and dimensions, and into which a cavity is to sandblasted;
b) Creating a mask made of Poly Vinyl Chloride (PVC) by creating one or more windows in the PVC material, each window having predetermined shape and size to define desired surface of the corresponding cavity;
c) Releasably adhering the PVC mask onto the surface of the slab, by, e.g., using a glue agent commonly known as “Super Glue”. The Super Glue includes cyanoacrylate (C₅H₅NO₂) as one of its ingredients, which ingredient is an acrylic resin that cures (forms its strongest bond) almost instantly when triggered by hydroxyl ions in water;
d) Sandblasting one or more cavities of predetermined depths in the slab through corresponding windows in the PVC mask; and
e) Removing the PVC mask from the slab by peeling it off the slab.

The present invention also discloses an ornamental slab, which is obtained by incorporating (two/three) dimensional ornamental elements into a cavity that is created in a slab. The cavities in the slab can be formed by either utilizing the sandblasting process described above, or by any alternative method. For example, the cavities can be created by utilizing drilling machine, laser beam, the energy of which can be tuned according to the desired depth of the cavity, or chemicals, or any combination thereof. In addition, a slab can be molded, with the desired cavities, using polymer materials, plasters, clay materials, or any combination thereof, or other suitable moldable material.

Preferably, the ornamental slab of the invention is obtained by:
a) Inserting into the one or more cavities in the slab two and/or three dimensional ornamental elements (e.g., dried flowers, shells of various kinds, clams, cockles, scallops, great scallops, blue mussels, various colored stones, metal elements, wood elements, plastic elements, mirrors, pearls, light sources, etc.). The ornamental elements occupy only some portion of the space of the cavity, and are, preferably, though not necessarily, secured (by, for example, the use of epoxy resin) to desired places in the cavity, and optionally, to one another, by optionally utilizing supporting elements and adhering agent. In another embodiment, some or all of the ornamental elements are not fixed to the cavity and/or to one another;
b) Covering the whole slab, or only the openings of the cavities thereof, with a covering sheet, or covering sheets, for protecting the ornamental elements residing within the cavities; and
c) Fixing the covering sheet(s) to the slab, or to the cavities thereof, using water resistant adhering agent, for providing sealing between the covering sheet and slab, in order to prevent water and moisture from entering the cavity.

According to an aspect of the present invention, the openings of the cavities are left uncovered, and one or more of the ornamental elements extend outwardly from the cavities, either surpassing the surface of the slab or not.

According to one embodiment of the present invention, the covering sheet is placed in a ledge that is sandblasted or otherwise formed, such as by being cut, in the upper portion of the walls of the cavity, for providing support to the covering sheet.

Preferably, the ledge is made such that the upper surface of the covering sheet; i.e., the side facing outwardly and away from the cavity, when placed on the ledge, is a continuation of the surface of the slab in the same plane. If desired, gaps can exist, or be left, between the covering sheet and the walls of the cavity, in order to fill them with caulking material, such as epoxy glue, which serves to secure the covering sheet to the ledge and for sealing the cavity, or cavities, within which the ornamental elements reside.

The external shape of the slab is selected from the group of {polygonal, circle, ellipse, oval}. Optionally, the external shape of the slab can be made such as that it conforms to any other desired shape.

The shape of the opening of each cavity may be selected from the group of {polygonal, circle, ellipse, oval}. Optionally, the shape of the opening can conform to any other desired shape.

The substance of the slab is preferably selected from the group consisting of: stone, marble, White Granite, wood, polymer, metal, clay.

Preferably, the sickness of the slab is about 8 millimeters minimum, for allowing sandblasting cavities that are deep enough to contain the desired decorative elements. However, in some cases, where the decorative elements are flat and occupy relatively very small space, slabs having thickness less than 8 millimeters can be used as well.

The substance of the mask can be selected from the group consisting of: Poly Vinyl Chloride (i.e., PVC), metal, rubber and polymer, though the PVC has been found by the inventor of the present invention to be the preferred material due to its resistance to the jet of sand and, in addition, because PVC is relatively easy to handle (i.e., cut, adhere, etc.).

According to one preferred embodiment of the present invention, ornamental slabs produced by the present invention are utilized as tiles, to cover walls or a floor of an apartment.

According to another preferred embodiment of the present invention, ornamental slabs produced by the present invention are individually incorporated into existing floors or walls of an apartment, or into other parts or elements thereof, for decoration purposes.

According to another preferred embodiment of the present invention, individual ornamental slabs produced according to the present invention are used as stand-alone decorative elements.

The covering sheet may be fully transparent or semi-transparent, in whole or in part(s) of it.

The covering sheet may be colored in whole or in parts. In this respect, the covering sheet may be mono-colored or multicolored, in whole or in part(s).

According to an aspect of the present invention, the covering sheet is glass, whether reinforced or hardened, or neither reinforced nor hardened. Optionally, the covering sheet may be made of a material commonly known as Perspex. According to yet another option, the covering sheet may be made of metal.

According to one embodiment of the present invention, the covering sheet includes one or more openings, which fully pass through the covering sheet. Each one of the openings is located in desired location relative to the location of the other openings, and relative to the circumference of the covering sheet. The openings may be irregularly distributed, or they may be distributed on a regular manner, or they may have any desired repeating pattern(s). The shape of the openings can be rounded, or it can conform to other shapes.

In another aspect, ornamental elements are secured in the openings and are partially protruding inwardly, viz. in the direction towards the cavity interior, and partially protruding outwardly, viz. towards a generally opposite direction and away from the cavity interior. Such ornamental element(s) can be, for example, a metal ball(s). Optionally, the ornamental elements can protrude only inwardly, or only outwardly, or not protrude at all.

In another embodiment of the invention, the surface of one side of the covering sheet is sandblasted to obtain desired carvings, and the sandblasted, or carved, side thereof faces inwardly, in a direction towards the cavity, or cavities.

According to another embodiment of the invention, the walls of the cavity are colored. The walls can be wholly or partially coated with a mono-colored or multicolored layer or film, or the desired color(s) can be applied to the walls such as by painting, spraying, or by any other suitable way. The color of the walls of the cavity may essentially match, or resemble, the general, dominant, color of the slab, or it can differ from it. According to an aspect of the invention, the color of the walls is the color of Gold.

According to another preferred embodiment of the present invention, at least one of the ornamental elements in a cavity is a light source, and if the cavity is covered with a covering sheet, the covering sheet is made of heat-resisting material (e.g., glass), and the covering sheet is releasably attached to the slab, for example, by drilling holes through the covering sheet and the slab and using screws, for allowing replacing the light source, should the need arise for any reason.

According to a first aspect of this embodiment, the ornamental slab includes one slab with a cavity large enough to contain a light source with its accessories (e.g., housing, support means, electrical cable, etc.). The ornamental slab could be utilized as decorative lighting source when standing alone, or when incorporated as a tile into a wall/floor cover. The cavity is formed in the slab in a way that the thickness of the wall of the slab (being the ‘bed’ of the cavity) has a width of only a few millimeters, making the bed of the cavity semi-transparent, for allowing at least a portion of the light radiated by the light source to pass through the bed of the cavity.

According to a second aspect of the latter embodiment, the ornamental slab includes two individual slabs that are joined to one another so that the open side of the cavities of the individual slabs face each other to form a common cavity capable of containing a light source with its accessories, thus utilizing the slab as a decorative lighting source when standing alone, or when incorporated as a tile into a wall, or floor. The light source and its related accessories (e.g., supporting means, electrical cable) are placed and secured in the cavity of the slab prior to them being sealed in the cavity.

According to an embodiment of the present invention, the light source is external to the cavity, and radiates light through the thin bed of the cavity.

According to an aspect of the present invention, the light source is selected from the group of: {Light Emitting Diode (LED), optical fiver, fluorescent lamp, phosphorescent materials, light bulb}.

According to an aspect of the present invention, some or all of the ornamental elements in a cavity are fixed to a corresponding place in the cavity, or loosely reside therein.

According to another embodiment, a slab-like element consists of two or more slices made of stone, stone-like material, or any other sliceable solid material, where the slices are adhered to one another, or secured to one another in any suitable way, after which the cavity, or cavities, is/are formed therein as described herein.

The planes of the slices can be, according to one aspect, perpendicular, or generally perpendicular, to the plane of the slab-like element, and parallel, or generally parallel, to one another. According to another aspect, each one the planes of the slices can be parallel, or generally parallel, to the plane of the slab, and parallel, or generally parallel, to one another.

Each one of the slices, from which the slab is consisted, may be made of a different material, and/or it may have a different thickness, width, length, color and/or shape.

According to yet another embodiment, one or more channels (hereinafter ‘light channels’) are made in the cavity or cavities, by drilling holes that pass through the slab, to allow light, which is emitted from a light source outside the ornamental slab, to penetrate, via the light channels, into the cavity or cavities for lightning the cavities and/or the ornamental/decorative elements residing therein, to obtain visual effects that are interested and appealing to a viewer.

In yet another embodiment, the covering sheet is supported by, and secured to, a ‘ledge element’, which provides the ledge needed to support and secure the covering sheet, and, being in itself a separate and intermediating element, secured to the wall(s) of the cavities, such as by being adhered to them. The ledge element may protrude with respect to the surface of the slab or not, and the ledge may be located in such a way that the upper surface of the covering sheet (i.e., the surface not facing the interior of the cavities) and the surface of the slab essentially lay wholly in the same geometrical plane. Alternatively, the ledge(s) may be so located, that the latter two surfaces lay in two different planes that may be either equidistantly spaced from one another, or not. For example, the surface of the covering sheet can be raised comparing to the surface of the slab, or it can be, according to another example, lower than the surface of the slab.

### BRIEF DESCRIPTION OF THE DRAWINGS

FIG. 1a is a sectional view of an exemplary ornamental slab, according to the principles disclosed in the present invention,

FIG. 1b shows a clearer picture of pattern of the exemplary ornamental element shown partially in FIG. 1a;

FIG. 1c is a perspective view of the exemplary ornamental slab shown in FIG. 1a;

FIG. 2 is a sectional view of another exemplary ornamental slab obtained according to the principles disclosed the present invention;

FIG. 3a schematically illustrates incorporation of a light source into a cavity, according to one preferred embodiment of the present invention;

FIG. 3b schematically illustrates incorporation of a light source into a cavity, according to another preferred embodiment of the present invention;

FIG. 4a is a schematic three dimensional illustration of a partial ledge formed in a cavity, according to one preferred embodiment of the present invention;

FIG. 4b is a cross-sectional view depicting the covering sheet placed on the ledge shown in part in FIG. 4a;

FIG. 4c shows a another view of the covering sheet placed on the ledge that was created in a slab;

FIGS. 5a to 5d schematically illustrate steps in making an exemplary ornamental slab, according to another preferred embodiment of the present invention;

FIGS. 6a to 6d schematically illustrate other exemplary ornamental slabs, according to some preferred embodiment of the present invention;

FIG. 7 schematically illustrates a covering sheet with openings, according to a fist example of the present invention;

FIG. 8 schematically illustrates a covering sheet with openings, according to a second example of the present invention;

FIGS. 9a and 9b schematically illustrate an example of a decorative element that is secured to an opening in the covering sheet, according to the present invention;

FIGS. 10a and 10b schematically illustrate an exemplary covering sheet where one of its surfaces had been carved, according to the present invention;

FIGS. 11a and 11b schematically illustrate two exemplary slab-like elements, with cavities, consisting of slices, according to the invention;

FIG. 12 schematically illustrates an exemplary slab with exemplary ‘light channels’, according to the invention; and

FIG. 13 schematically illustrates exemplary utilization of a ‘ledge element’, according to the invention.

### DETAILED DESCRIPTION OF PREFERRED EMBODIMENTS

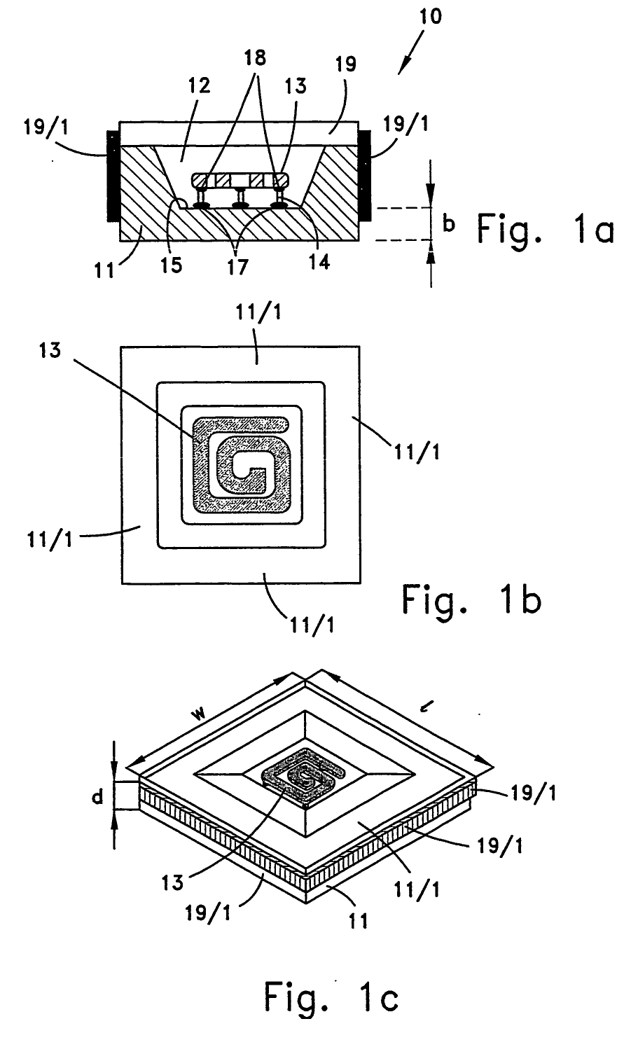

FIG. 1 is a sectional view of an exemplary ornamental slab, according to the principles disclosed in the present invention. Ornamental slab 10 comprises, e.g., stone 11, in which cavity 12 is cut, preferably by sandblasting stone 11. Ornamental element 13 (best shown in FIG. 1b) is secured in cavity 12 by utilizing supporting elements 14. The proximal end of supporting elements 14 (in this example, a total of three supporting elements) is adhered (17) to bed 15 of cavity 12, by utilizing corresponding adhering agent (e.g., Epoxy resin). Then, ornamental element 13 is put in its place in cavity 12 and adhered (18) to the distal end of supporting elements 14. Covering sheet (e.g., made of glass) 19 is then put against the open side of cavity 12, for providing sealing (i.e., against water and moisture) and mechanical protection to ornamental element 13. Covering glass 19, which could be fully transparent in whole or in part, fully colored, or a combination of transparent and colored, has a shape and dimensions (i.e., ‘w’ and ‘l’) that essentially match those of the surface of stone 11, as clearly shown in FIG. 1c. Of course, the glass can be replaced with any suitable material, for example, by Perspex or other type of plastic. Covering glass 19 is, then, secured to its position on stone 11, by utilizing a layer 19/1 of water resistant glue, which completes the sealing of the content of cavity 12 (in this example, ornamental element 13). Other types of, two or three dimensional, ornamental elements could be placed in cavity 12, and the number, size, shape and relative location in cavity 12, of supporting elements, would conform to the characteristics of the ornamental element(s) inserted into cavity 12, and, optionally, on the desired artistic effect.

The cavity is obtained by releasably adhering a wear proof mask (not shown) onto the surface of the slab 11, which wear proof mask having a window with the preferred shape and size (i.e., of the desired cavity opening), and sandblasting slab 11 through the window in the wear proof mask. The wear proof mask is preferably PVC.

The characteristics of the sand used in the sandblasting process are as follows:
1. Distribution of the granular sizes: at least 60% of the particles have a size ranging from 0.60 to 0.85 millimeter. In addition:
Granular size larger than 0.85 millimeter—30% (maximum);
Granular size smaller than 0.60 millimeter—30% (maximum);
2. Chemical characteristics of the sand: SiO₂ (98.5%, minimnum); Fe₂O₃ (0.15%, maximum); Al₂O₃ (0.4-0.6%); CaO+MgO (0.1-0.2%); and NaO+K₂O (0.10%, maximum).
3. Mineralogical characteristics of the sand: the sand particles contain a very high percentage of quartz.
4. Hardness of the particles: 7 (according to Mohs hardness scale).

The covering sheet is adhered to the slab, by wrapping both the perimeters of the slab and covering sheet, as schematically shown in FIGS. 1a and 1c (reference numeral 19/1), by utilizing the 5300 Acrylic Double Sided glue agent (manufactured by Scapa Tapes Company), which is an acrylic adhesive with a solid acrylic core and a white siliconized release liner.

Exemplary but not limiting dimensions of slab 11 are: thickness=‘d’ (d=15-25 mm), Width=‘w’, Length=‘l’, wherein ‘w’ and ‘l’ are taken from the group: {5 cm, 10 cm, 15 cm, 20 cm, 16.5 cm, 25 cm, 30 cm, 33 cm, 40 cm, 45 cm, 50 cm, 55 cm, 60 cm, 80 cm}. For example, ‘w’ and ‘l’ could be 15 cm and 55 cm, respectively. Of course, the slabs could essentially have any other practical dimensions. For example, a slab can be 2.40 meters wide and 3.60 meters long. FIG. 1c is a perspective view of the exemplary ornamental slab shown in FIG. 1a;

If it is desired to utilize an ornamental slab, such as the ornamental slab shown in FIG. 1c, for covering floors or walls, such as of buildings, swimming pools, etc., it is possible to use a stainless grout known by its commercial name as LATAPOXY SP-100 (manufactured by LATICRETE International, Inc., U.S.A.). LATAPOXY SP-100 is a stainless epoxy grout specifically designed for use in floor and wall applications of ceramic tile, stone and structural glazed block. LATAPOXY SP-100 efficiently resists many acids, alkalis and corrosives.

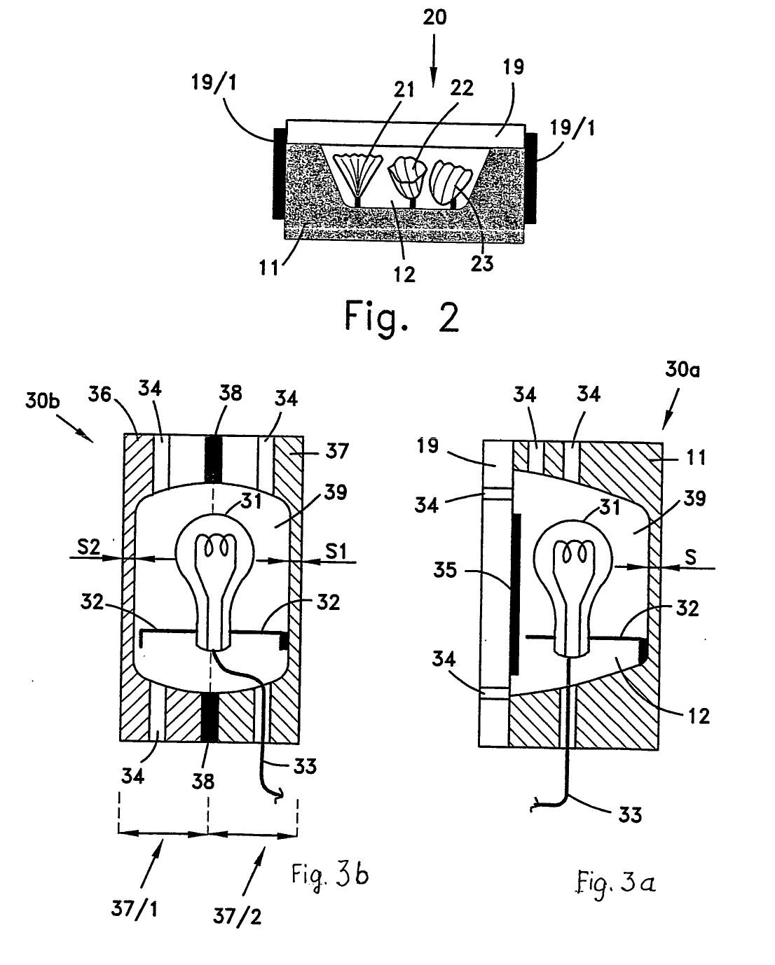

FIG. 2 is a sectional view of another exemplary ornamental slab, according to the principles disclosed in the present invention. FIG. 2 shows ornamental slab 20 that includes two sea-shells (i.e., 21 and 22) and heart-like ornamental piece (i.e., 23). Of course, other, or different, three dimensional ornamental elements could be inserted into a cavity of a slab.

FIG. 3a schematically illustrates incorporating a light source into a cavity, according to one preferred embodiment of the present invention. Ornamental slab 30a comprises slab 11, into which cavity 12 was sandblasted, covering glass 19, and light source 31 with its related accessories. Light source 31 is inserted into cavity 12 and secured thereto by supporting means 32. Slab 11 includes an opening, for allowing insertion of-an electrical cable 33, to provide the electric energy required to operate light source 31. Slab 11 includes also ventilation openings 34, for allowing dissipation of the heat generated by light source 31. Cavity 12 of slab 11 is so deep, that the thickness (S) of the wall is only a few millimeters, which makes it semi-transparent. In this location, light source 31 will radiate light through the thin wall of slab 11 (S being equal to, e.g., 3 mm) and through covering glass 19, which could be fully, or partially, transparent, or colored in whole or in portions thereof. Optionally, a reflective surface (e.g., mirror) adhered onto the interior face of covering glass 19 would cause the light generated by light bulb 31 to radiate in one direction only. Ornamental slab 30a is intended to be utilized as decorative lighting source when standing alone, or when incorporated into a wall, or floor, cover.

FIG. 3b schematically illustrates incorporation a light source between two slabs, according to another preferred embodiment of the present invention. Ornamental slab 30b is formed by joining two slabs, such as slab 11, together, so that the open side of their cavities faces each other to form a common cavity 39. Ornamental slab 30b also comprises light source 31, with its related accessories (including supporting means 32 and electrical cable 33). Light source 31 is secured in place in cavity 39 prior to the joining of the two slabs (37/1 and 37/2) together, by means of a water resistant glue (e.g., Epoxy resin), schematically indicated by reference numeral 38.

One of slab 37/1 or 37/2 includes an opening for insertion of an electrical cable 33, to provide the electric energy required to operate light source 31. Slab 37/1 and/or 37/2 also have ventilation openings 34, for allowing dissipation of the heat that is generated by light source 31. Cavity 39 of slabs 37/1 and 37/2 is so deep, that the thickness of the walls (S1 and S2) is only a few millimeters, which makes the walls semi-transparent. Light source 31 irradiates light through the thin walls of slabs 37/1 and 37/2. The two halves of ornamental slab 30b could have the same or different colored walls. Ornamental slab 30b is intended to be utilized as decorative lighting source when standing alone, or when incorporated into a wall.

Ornamental slabs 30a or 30b can have a shape other than rectangular, and the ornamental elements can be fixedly positioned in a cavity, or loosely reside therein.

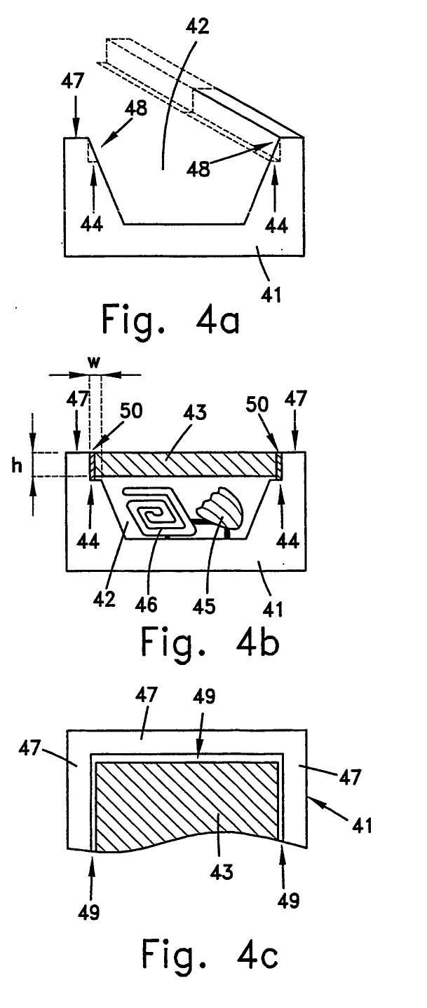

FIGS. 4a to 4c schematically illustrate using a ledge for supporting the covering glass in a slab, according to one preferred embodiment of the present invention. FIG. 4a shows a cross-sectional view of a slab, for illustrating the relative location of the ledge, with respect to the walls of the cavity. FIG. 4b shows a cross-sectional view of the slab with the covering glass 43 lying on the ledge 44. After cutting cavity 42 in slab 41, a ledge (44) is cut in the upper portion of the cavity walls 48 (only two opposite walls are shown). Removing the excess material from the walls of cavity 42, results in formation of the ledge 44, onto which covering glass 43 is laid (after placing and securing ornamental elements, for example, ornamental elements 45 and 46, inside cavity 42). The height ‘h’ of the ledge 44 essentially matches the thickness of covering glass 43, and the width w of the ledge 44 is adequate for supporting covering glass 43. Ideally, the surface of covering glass 43 is a continuation of surface 47 of slab 41. However, if the upper surface of covering glass 43 is found to be lower than surface 47 the covering glass can be conveniently raised to the correct level. Filling gap 49 with caulking material 50 (FIG. 4b) seals the contact area between covering glass 43 and slab 41, for protecting ornamental elements 45 and 46, and also secures covering glass 43 to ledge 44.

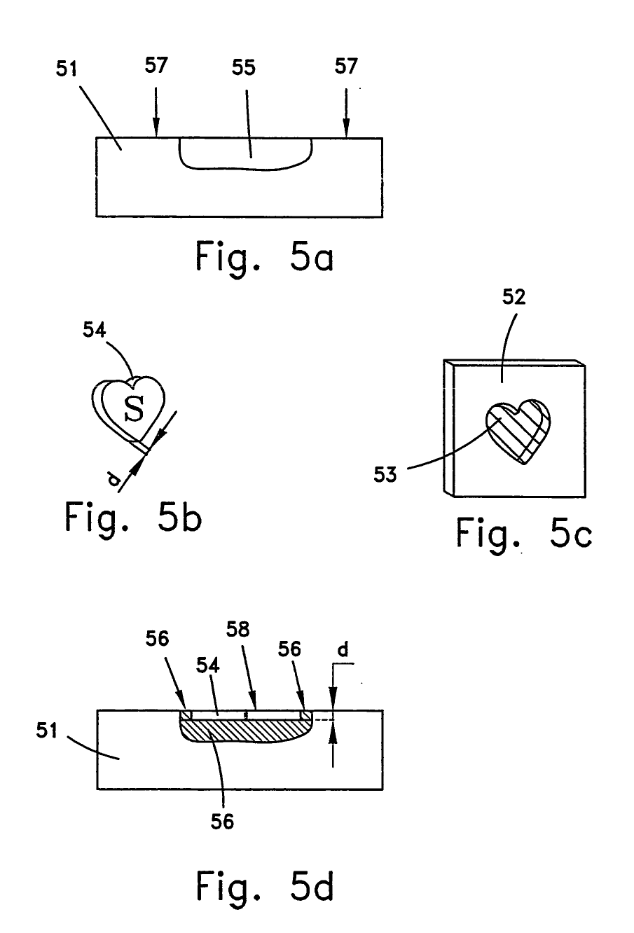

FIG. 5a to 5d schematically illustrates embedding exemplary ornamental element into a slab, according to another preferred embodiment of the present invention. Ornamental element 54 is intended to be embedded into slab 51. To accomplish this, cavity 55 is created in slab 51 by sandblasting by using mask 52, which includes a window whose contour line is essentially identical to the contour line of ornamental element 54. The depth of cavity 55 is more than the thickness ‘d’ of ornamental element 54, in order to allow cavity 55 to conveniently accept ornamental element 54 (FIG. 5d). Cavity 55 is partially filled with mortar 56, onto which ornamental element 54 is laid. Caulking 56 is then used to fill the volume around ornamental element 54 securing it in its place, and to beautify the general appearance of the slab and ornament. According to the example shown in FIG. 5, surface 57 of slab 51, surface 58 of ornamental element 54 and the surface of caulking 56 form one continuous surface in the same plane. However, this is not necessary, and the relative height of surface 58, with respect to surface 57, can be according to the desired artistic effect.

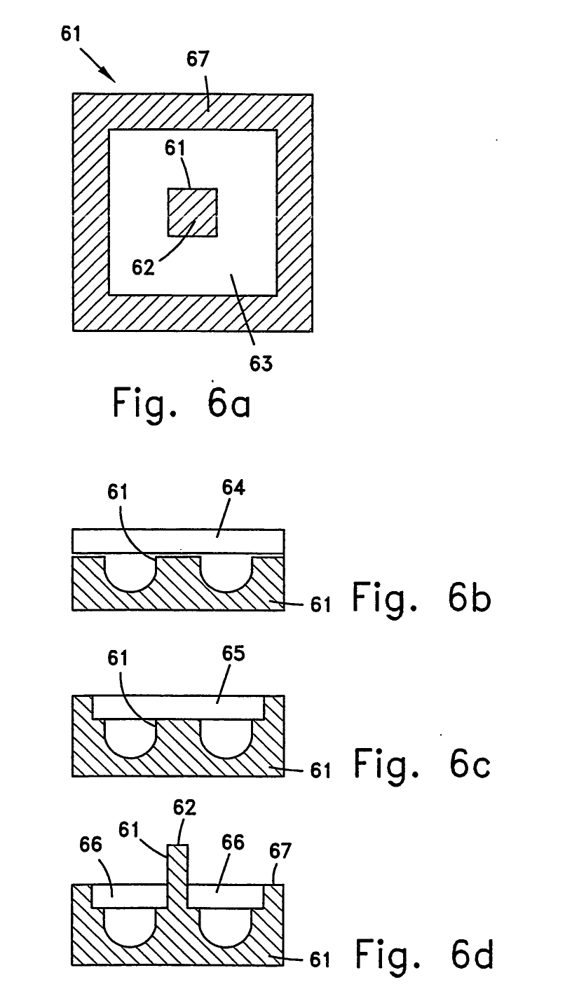

FIG. 6a schematically illustrates exemplary tile made according to the present invention. The width, length, and thickness of slab 61 can be, for example, 100×100×30 centimeters. In the middle portion of cavity 63 there is a surface 62 that is raised relative to the bottom of cavity 63. Surface 63 can be in the same plane as surface 67 of slab 61, as shown in FIG. 6b, lower than surface 67, as shown in FIG. 6c, or higher than surface 67, as shown in FIG. 6d. In the latter case, surface 62 can be utilized as a table or a chair. A light source (not shown) can be incorporated into cavity 63 for decoration purpose. Reference numerals 64 to 66 denote a covering sheet in the respective Figs.

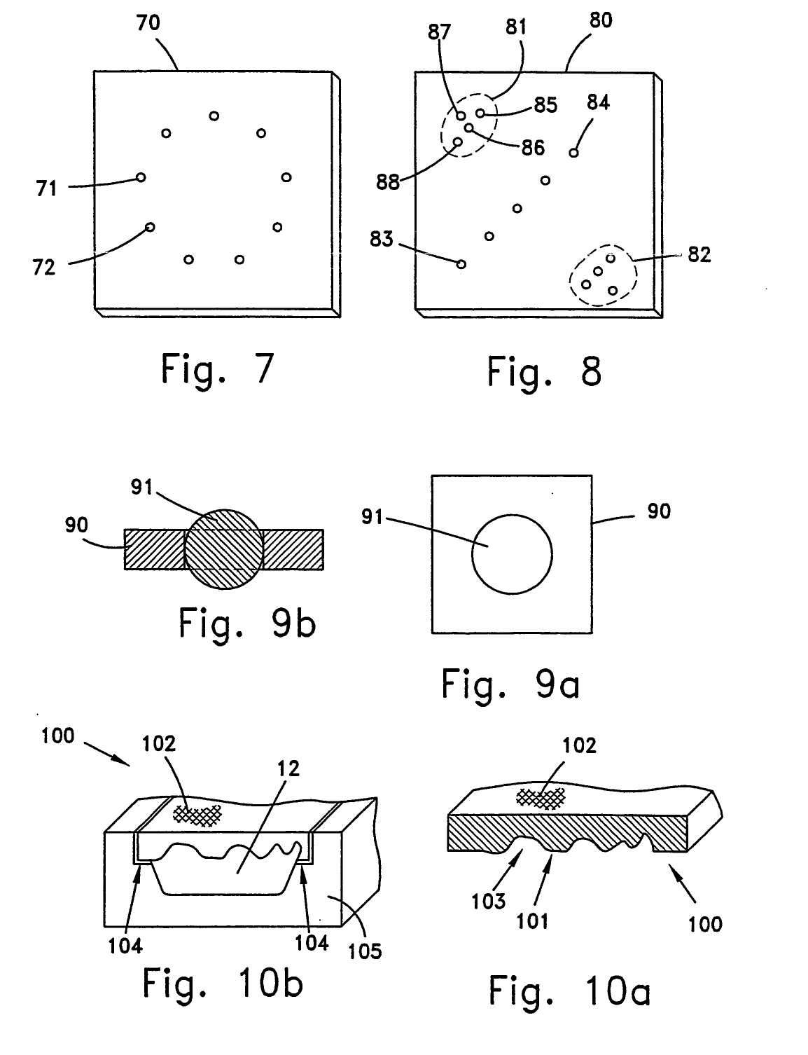

FIG. 7 schematically illustrates a first example of a covering sheet with openings, according to the present invention. Covering sheet 70 includes, according to this example, nine openings that pass through it (only two of which are designated by numerical references; i.e., openings 71 and 72). Covering sheet 70 is shown having a rectangular shape and the openings (e.g., 71, 72) are shown having rounded shape. However, the covering sheet and the openings may desirably have any other shape. According to this example, the openings (e.g., 71, 72) are arranged in a circle-like manner.

FIG. 8 schematically illustrates a second example of a covering sheet with openings, according to a second example of the present invention. Covering sheet 80 includes, according to this example, thirteen openings that pass through it (only six of which are designated by numerical references; i.e., openings 83 to 88). Covering sheet 80 is shown having a rectangular shape and the openings, for example openings 83 and 85, are shown having rounded shape. However, the covering sheet and the openings may desirably have any other shape.

According to this example, openings 85, 86, 87 and 88 are shown arranged in a desired pattern, which is shown circumscribed by dotted line 81. Likewise, other openings are shown arranged in another desired pattern, which is shown circumscribed by dotted lines 82. The pattern circumscribed by dotted line 82 is identical to the pattern circumscribed by dotted line 81, though it has a different orientation, but this not necessarily so.

In addition, covering sheet 80 includes a series of openings that are arranged along an imaginary line. Opening 83 is the first, or last, opening in the line, whereas opening 84 is the last, or first, opening in the line.

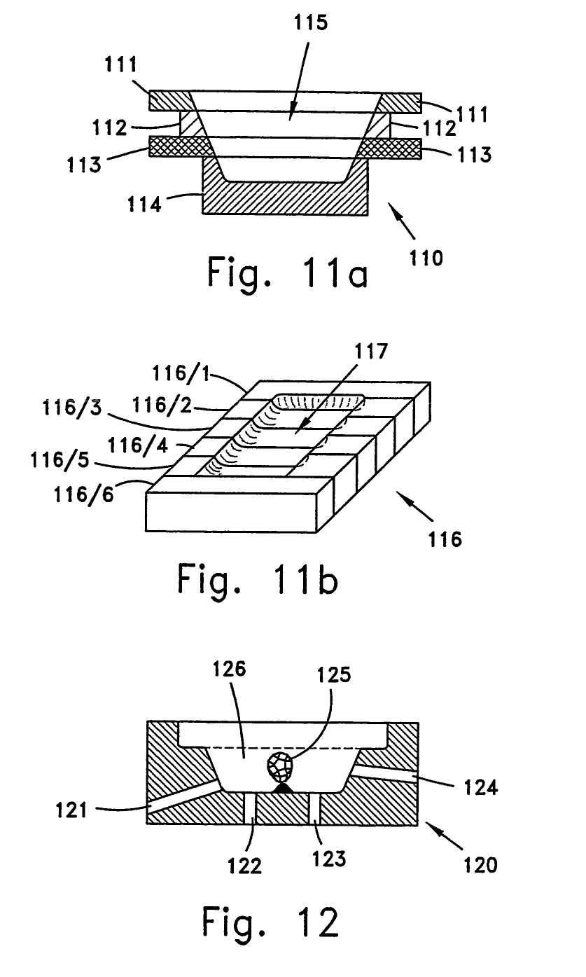

FIGS. 9a and 9b schematically illustrate an example of a decorative element that is secured in an opening in the covering sheet, according to the present invention. In FIGS. 9a and 9b, a ball-like element 91 is the decorative element. FIG. 9a shows a top view of the ball-like element 91 secured to its place in a rounded opening in cover sheet 90, whereas FIG. 9b shows a side cross-sectional view of the cover sheet and element 91. In the example shown in FIGS. 9a and 9b, the decorative element, viz. ball-like element 91, is shown protruding to both directions with respect to cover sheet 90 (in FIG. 9b upwards and downwards). As described above, the decorative element may protrude only in one direction, viz. either upwards or downwards), or it may not protrude at all.

FIGS. 10a and 10b schematically illustrate an exemplary covering sheet where one of its surfaces had been carved, according to an embodiment of the present invention. As shown in FIG. 10a, surface 102 of covering sheet 100 is flat and smooth, whereas surface 101 of covering sheet 100 is schematically shown as having exemplary carvings (i.e., 103), and is, therefore, referred to hereinafter as the ‘carved surface’.

FIG. 10b shows the carved surface 101 of covering sheet 100 faces downwards; viz. towards the direction of cavity 12, whereas the smooth surface thereof faces outwardly, viz. in the direction opposite to the direction of cavity 12 and away from it.

FIG. 11a schematically illustrates an exemplary slab-like element that consists of slices, the planes of which are parallel to one another and to the plane of slab-like element 110. Slab-like element 110 consists of slices 111 to 114, which may be cut from desired solid materials. For example, slice 111 can be sliced from one kind of stone, slice 112 from a different kind of stone, etc. According to another example, one or more slices (e.g., slice 113) can be a piece of metal, wood, plastic, and so on.

After securing slices 111 to 114 to one another, such as by adhering them to one another, a cavity, such as cavity 115, is formed in slab 110.

FIG. 11b schematically illustrates another exemplary slab-like element that consists of slices, the planes of which are parallel to one another and perpendicular to the plane of slab-like element 116. Slab-like element 116 consists of slices 116/1 to 116/6, which may be cut from desired solid materials. Cavity 117 is formed in slab-like element 116 in a way described herein, and a covering sheet (not shown) is placed thereon using a corresponding ledge (not shown), which may be desirably formed in the walls of the cavity as described herein, or it may be a ledge element, chosen to obtain a slab of some desired appearance.

FIG. 12 schematically illustrates an exemplary slab with exemplary ‘light channels’, according to the invention. ‘Light channels’, such as light channels 121 to 124 are formed in slab 120, by drilling there through corresponding holes. Light, whether natural or artificial, is allowed to pass through light channels 121 to 124 to allow the light to enter cavity 126 to light it up, as well as ornamental element 125, whereby to render the appearance of slab 120 appealing to a viewer (not shown).

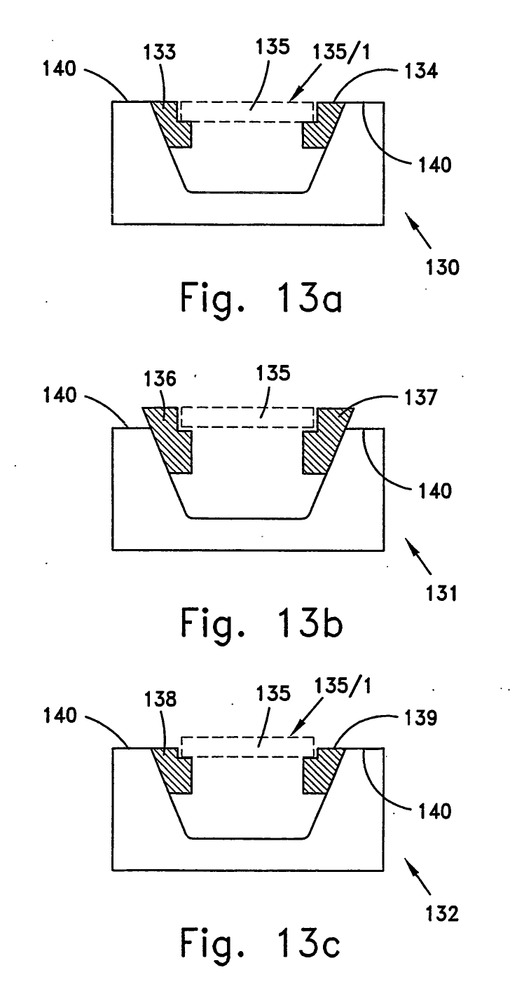

FIGS. 13a to 13c schematically illustrate exemplary utilization of a ‘ledge element’, according to the invention. In FIG. 13a, ledge elements 133 and 134 are shown not protruding from the surface 140 of slab 130, and covering sheet 135 is secured to them in a way that the external surface of the covering sheet (i.e., surface 135/1) and the surface of slab 130 (i.e., surface 140) essentially lay in the same geometrical plane, which is shown also in FIG. 13b, except that in FIG. 13b, the ‘ledge elements’ (numerically referenced as 136 and 137) protrude from the surface 140.

In FIG. 13c, the ledges of ‘ledge elements’ 138 and 139 are so located, that surfaces 131/1 and 140 do not lay in the same plane, but, rather, they lay in two, different planes that are essentially equidistantly spaced from one another, though their planes may otherwise relate to one another.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. Method for rapidly making deep cavities in a slab, comprising:
a) Providing said slab with a desired shape and dimensions, into which one or more cavities are to be sandblasted;
b) Creating a mask made of PVC by creating one or more windows in a PVC, each window having predetermined shape and size to define desired surface of the corresponding cavity;
c) Releasably adhering said PVC mask onto the surface of said slab;
d) Forming, through said windows, one or more cavities of predetermined depths in the slab; and
e) Removing said PVC mask from said slab by peeling it off said slab.

2. Method according to claim 1, wherein the cavities in the slab are formed by utilizing sandblasting technique that includes spraying through the window(s) particles with hardness degree of 7 or harder than 7, by utilizing air that is pressurized to at least 7 atmospheres.

3. Ornamental slab, said ornamental slab including one or more cavities large enough to include therein two and/or three dimensional ornamental elements that occupy only some portion of the space of said cavities.

4. Ornamental slab according to claim 3, in which the whole ornamental slab, or only the openings of the one or more cavities thereof, is/are covered by a covering sheet, or covering sheets, for providing air and liquid tight sealing for protecting said cavities and the ornamental elements contained therein; said covering sheet(s) being affixed to said slab, or to said openings, in a way that allows obtaining said sealing and protection.

5. (canceled)

6. (canceled)

7. (canceled)

8. (canceled)

9. Ornamental slab according to claim 3, wherein the ornamental elements are selected from the group of: {dried flowers, shells of various kinds, clams, cockles, scallops, great scallops, blue mussels, colored stones, metal, wood or plastic elements, mirrors, pearls, light sources}.

10. Ornamental slab according to any of claim 4, wherein the covering sheet is placed in a ledge being created in the upper portion of the walls of the cavity or cavities.

11. Ornamental slab according to claim 10, wherein the ledge is created by sandblasting the walls of the cavity, such that the upper surface of the covering sheet, when placed on said ledge, is a continuation of the surface of the slab in the same plane, and gaps are left between said covering sheet and said walls, in order them to be filled with caulking material, for securing said covering sheet to said ledge and for sealing the cavity, or cavities, in which ornamental elements reside.

12. (canceled)

13. (canceled)

14. (canceled)

15. (canceled)

16. Ornamental slab according to claim 3, wherein ornamental slabs are utilized as tiles to cover walls and/or floor.

17. (canceled)

18. Ornamental slab according to claim 3, wherein individual ornamental slabs are used as stand-alone decorative elements.

19. Ornamental slab according to claim 4, wherein the covering sheet is fully transparent or semi-transparent, in whole or in part(s).

20. (canceled)

21. (canceled)

22. (canceled)

23. (canceled)

24. (canceled)

25. Ornamental slab according to claim 4, in which the surface of one side of the covering sheet is sandblasted to obtain desired carvings, and the sandblasted side thereof faces inwardly, in the direction of said cavity, or cavities.

26. (canceled)

27. (canceled)

28. (canceled)

29. (canceled)

30. (canceled)

31. Ornamental slab according to claim 4, wherein at least one of the ornamental elements in the cavity, or cavities, of an ornamental slab is a light source, said cavity, or cavities, being formed such that the thickness of the ‘bed’ of said cavity, or cavities, is only a few millimeters, making said bed semi-transparent, for allowing at least a portion of the light radiated by said light source to pass through said bed; and the covering sheet is made of heat-resisting material and is releasably attached to the slab, for allowing replacing said light source, said ornamental slab being utilized as decorative lighting source when standing alone, or when incorporated into a wall/floor cover as a tile.

32. Ornamental slab according to claim 31, wherein the ornamental slab includes one slab with a cavity large enough to contain the light source with its accessories.

33. (canceled)

34. (canceled)

35. Ornamental slab according to claim 9, wherein the light source is selected from the group of: {Light Emitting Diode (LED), optical fiver, fluorescent lamp, phosphorescent materials, light bulb}.

36. Ornamental slab according to claim 3, wherein one or more of the ornamental elements extend outwards from the cavity, surpassing the surface of the slab.

37. Ornamental slab according to claim 3, wherein the cavity, or cavities, of the ornamental slab is/are filled with mortar into which one or more ornamental elements are placed; and the gaps, between said ornamental elements and the walls of said cavity, or cavities, is filled with caulking material, for sealing the gaps and for securing the location of said ornamental elements within said cavity or cavities.

38. Ornamental slab according to claim 3, wherein the cavities in the slab are formed by utilizing drilling machine, or laser technology, or chemicals, or sandblasting, or any combination thereof.

39. Ornamental slab according to claim 38, wherein the sandblasting includes using a jet of particles having at least hardness 7, that are carried by a stream of air pressurized to seven atmospheres minimum.

40. Ornamental slab that is made according to a method for rapidly making deep cavities in a slab, comprising:
a) Providing said slab with a desired shape and dimensions, into which one or more cavities are to be sandblasted;
b) Creating a mask made of PVC by creating one or more windows in a PVC, each window having predetermined shape and size to define desired surface of the corresponding cavity;
c) Releasably adhering said PVC mask onto the surface of said slab;
d) Forming, through said windows, one or more cavities of predetermined depths in the slab; and
e) Removing said PVC mask from said slab by peeling it off said slab;
wherein said slab consists of two or more slices made of stone, stone-like material, or any other sliceable solid material, where said slices are adhered to one another, or secured to one another in any suitable way.

41. (canceled)

42. (canceled)

43. (canceled)

44. Ornamental slab according to claim 40, wherein one or more ‘light channels’ are made in the cavity or cavities, by drilling holes that pass through the slab, to allow light, which is emitted from a light source outside the slab, to penetrate, via said light channels, into the cavity or cavities for illuminating the cavities and/or the ornamental/decorative elements residing therein, to obtain interesting visual effects that are appealing to a viewer.

45. Ornamental slab according to claim 4, wherein the covering sheet is supported by, and secured to, a ‘ledge element’, being in itself a separate and intermediating element and secured to the wall(s) of the cavities, said ledge element may protrude with respect to the surface of the slab, and it may be located such that the upper surface of said covering sheet and the surface of said slab essentially lay wholly in the same plane, or, alternatively, said ledge is located such that the latter two surfaces lay in two different planes that may be equidistantly spaced from one another.
